(19) United States
(12) Patent Application Publication
(10) Pub. No.: US 2023/0098126 A1
(43) Pub. Date: Mar. 30, 2023

(54) SHOP SYSTEM, PROCESSING METHOD, AND NON-TRANSITORY STORAGE MEDIUM

(71) Applicant: NEC Corparation, Minato-ku, Tokyo (JP)

(72) Inventors: Takahiro MATSUI, Tokyo (JP); Jun UCHIMURA, Tokyo (JP); Yasuyo KAZO, Tokyo (JP)

(73) Assignee: NEC Corparation, Minato-ku, Tokyo (JP)

(21) Appl. No.: 17/801,858

(22) PCT Filed: Dec. 24, 2020
(86) PCT No.: PCT/JP2020/048499

§ 371 Date: Aug. 24, 2022

(30) Foreign Application Priority Data
Mar. 9, 2020 (JP) 2020-049289

(51) Int. Cl. G06Q 30/06; G06Q 40/02; G06V 40/20

(52) U.S. Cl. CPC G06Q 30/06; G06Q 40/02; G06V 40/20

(57) ABSTRACT

The present invention provides a shop system (10) including: an acquisition unit (13) that acquires, from an information acquisition terminal (12), person-related information about a person who visits a shop; a determination unit (14) that determines, based on the person-related information, whether to permit the person who visits the shop to enter the shop; and an operation control unit (16) that controls, based on a result of the determination, operation of a shop entry control apparatus (11) that controls entry into the shop.

### TECHNICAL FIELD

The present invention relates to a shop system, a processing method, and a program.

### BACKGROUND ART

Patent Documents 1 and 2 disclose a technique for detecting a suspicious person in a shop.

### Related Document

### Patent Document

[Patent Document 1] Japanese Patent Application Publication No. 2007-074330
[Patent Document 2] Japanese Patent Application Publication No. 2004-328622

### DISCLOSURE OF THE INVENTION

### Technical Problem

0 In an unmanned shop or a manpower-saving shop that has been studied in recent years, on-site shop monitoring by a clerk is not performed or insufficiently performed. Therefore, some means of ensuring safe business operation are required. The technique in Patent Documents 1 and 2 is a technique for detecting a suspicious person among those who enter a shop. In a case of this technique, a suspicious person is allowed to enter a shop. When a 5 suspicious person enters a shop, the suspicious person can touch a product or a shop facility, which increases a risk of hindering safe business operation.

Note that, a similar problem can occur also in a normal shop with an on-site clerk, since it is difficult for the clerk to monitor all areas of the shop all times.

An object of the present invention is to provide a technique for ensuring safe business operation in a shop.

### Solution to Problem

According to the present invention,
a shop system including:
an acquisition unit that acquires, from an information acquisition terminal, person-related information about a person who visits a shop;
a determination unit that determines, based on the person-related information, whether to permit the person who visits the shop to enter the shop; and
an operation control unit that controls, based on a result of the determination, operation of a shop entry control apparatus that controls entry into the shop is provided.

Also, according to the present invention,
a processing method including:
by a computer,
acquiring, from an information acquisition terminal, person-related information about a person who visits a shop;
determining, based on the person-related information, whether to permit the person who visits the shop to enter the shop; and
controlling, based on a result of the determination, operation of a shop entry control apparatus that controls entry into the shop is provided.

Also, according to the present invention,
a program causing a computer to function as:
an acquisition unit that acquires, from an information acquisition terminal, person-related information about a person who visits a shop;
a determination unit that determines, based on the person-related information, whether to permit the person who visits the shop to enter the shop; and
an operation control unit that controls, based on a result of the determination, operation of a shop entry control apparatus that controls entry into the shop is provided.

### Advantageous Effects of Invention

According to the present invention, a technique for ensuring safe business operation in a shop is achieved.

### BRIEF DESCRIPTION OF THE DRAWINGS

FIG. 1 is a diagram for describing an outline of a shop system according to the present example embodiment.

FIG. 2 is a diagram illustrating one example of a hardware configuration of the shop system according to the present example embodiment.

FIG. 3] FIG. 3 is one example of a functional block diagram of the shop system according to the present example embodiment.

FIG. 4 is a flowchart illustrating one example of a processing flow of the shop system according to the present example embodiment.

FIG. 5 is a diagram schematically illustrating one example of information processed by the shop system according to the present example embodiment.

FIG. 6 is a diagram schematically illustrating one example of transaction information according to the present example embodiment.

### DESCRIPTION OF EMBODIMENTS

### First Example Embodiment

First, an outline of a shop system according to the present example embodiment is described. The shop system includes a function of detecting a person who has a possibility to hinder safe business operation among those who visit a shop and refusing entry into the shop to the detected person.

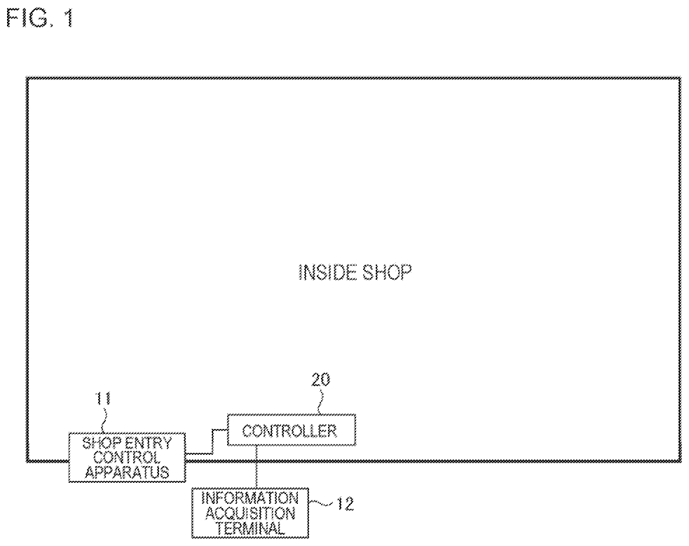

More specifically, as illustrated in FIG. 1, the shop system includes a shop entry control apparatus 11 that controls entry into the shop. The shop entry control apparatus 11 is, for example, a gate, an automatic door, and the like. Before a person who visits the shop passes through the shop entry control apparatus 11 and enters the shop, a controller 20 in the shop system acquires person-related information, which is information about the person, via an information acquisition terminal 12 installed in a vicinity of the shop entry control apparatus 11. Then, the controller 20 determines whether to permit the person to enter the shop, based on the acquired person-related information. Further, the controller 20 controls operation (opening and shutting, and the like) of the shop entry control apparatus 11, based on a result of the determination.

Note that, in the present description, “entry into the shop” means a state in which a person has passed through the shop entry control apparatus 11 and gone inside the shop. Further, “visit the shop” means a state in which a person has arrived at the shop but has not yet passed through the shop entry control apparatus 11 and gone inside the shop. Specifically, a “person who visits the shop” is a person who has arrived at the shop but has not yet passed through the shop entry control apparatus 11 and gone inside the shop.

Such a shop system can prevent a person who has a possibility to hinder safe business operation from entering the shop, and therefore occurrence of an inconvenience that hinders safe business operation can be reduced.

Next, one example of a hardware configuration of the shop system is described. A functional unit included in the shop system according to the present example embodiment is achieved by any combination of hardware and software, mainly including a central processing unit (CPU) of any computer, a memory, a program loaded into the memory, a storage unit (capable of storing a program that has been stored in advance from a stage of shipping an apparatus, as well as a program downloaded from a storage medium such as a compact disc (CD), a server on the Internet, or the like) storing the program, and an interface for network connection. It is understood by those skilled in the art that there are various modification examples of a method and an apparatus for achieving the functional unit.

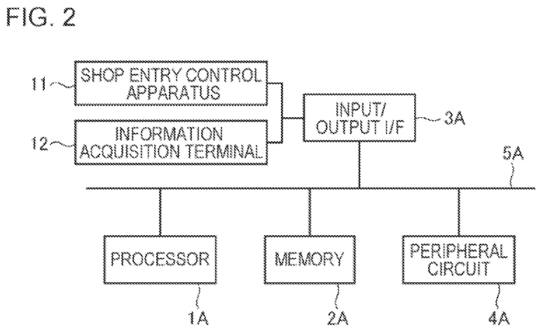

FIG. 2 is a block diagram illustrating a hardware configuration of the shop system according to the present example embodiment. As illustrated in FIG. 2, the shop system includes a processor 1A, a memory 2A, an input/output interface 3A, a peripheral circuit 4A, and a bus 5A. The peripheral circuit 4A includes various modules. Note that, the shop system may not include the peripheral circuit 4A. Note that, the shop system may be configured by a single apparatus that is physically and/or logically integrated, or may be configured by a plurality of apparatuses that are physically and/or logically separated. When the shop system is configured by the plurality of apparatuses that are physically and/or logically separated, each of the plurality of apparatuses may have the above-described hardware configuration.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from the information acquisition terminal 12, an input apparatus, an external apparatus, an external server, an external sensor, a camera, and the like, and an interface for outputting information to the shop entry control apparatus 11, an output apparatus, an external apparatus, an external server, and the like, and the like. The input apparatus is, for example, a keyboard, a mouse, a microphone, a touch panel, a physical button, a camera, and the like. The output apparatus is, for example, a display, a speaker, a printer, a mailer, and the like. The processor 1A is capable of issuing an instruction to each module, and performing an arithmetic operation, based on results of the arithmetic operation.

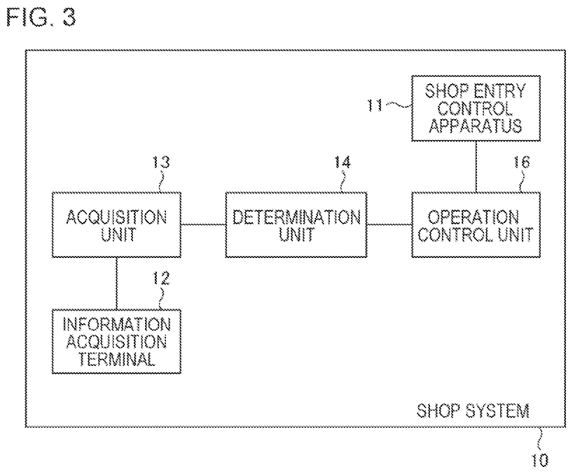

Next, a functional configuration of a shop system 10 is described. One example of a functional block diagram of the shop system 10 is illustrated in FIG. 3. As illustrated, the shop system 10 includes the shop entry control apparatus 11, the information acquisition terminal 12, an acquisition unit 13, a determination unit 14, a storage unit 15, and an operation control unit 16.

The shop entry control apparatus 11 is an apparatus that controls entry into a shop. The shop entry control apparatus 11 is, for example, a gate or an automatic door. The shop entry control apparatus 11 can be in a first state (a state in which a gate or a door is open) in which passage (entry into the shop) is permitted and a second state (a state in which the gate or the door is closed) in which passage (entry into the shop) is refused. Further, the shop entry control apparatus 11 performs an operation of transitioning between the first state and the second state, based on a control signal (electric signal) transmitted by the operation control unit 16, which will be described below.

The acquisition unit 13 acquires, from the information acquisition terminal 12, person-related information about a person who visits the shop. The information acquisition terminal 12 is installed in a vicinity of the shop entry control apparatus 11.

For example, the information acquisition terminal 12 may be a camera, and an image capturing the person who visits the shop may be acquired as the person-related information of the person.

Otherwise, for example, the information acquisition terminal 12 may be a microphone, and voice data in which a content of a speech of the person who visits the shop is recorded may be acquired as the person-related information of the person.

Otherwise, for example, the information acquisition terminal 12 may be a biological information acquisition apparatus, and biological information of the person who visits the shop may be acquired as the person-related information of the person. Examples of the biological information include, but are not limited to, fingerprint information, iris information, face information, voiceprint information, and the like. The biological information acquisition apparatus is an apparatus that acquires those pieces of biological information, and examples of the biological information acquisition apparatus include, but are not limited to, a fingerprint sensor, a camera, a microphone, and the like.

Otherwise, for example, the information acquisition terminal 12 may be a reader, and may perform near-field communication with a device (a smartphone, a smartwatch, a tablet terminal, a mobile phone, an integrated circuit (IC) card, an IC tag, and the like) possessed by the person who visits the shop, and personal identification information stored in the device may be acquired as the person-related information of the person.

Otherwise, for example, the information acquisition terminal 12 may be an input apparatus such as a touch panel, a physical button, a microphone, a keyboard, or a mouse, and personal identification information input via the input apparatus by the person who visits the shop may be acquired as the person-related information of the person.

Otherwise, for example, the information acquisition terminal 12 may be any sensor, and information indicating a state of the person who visits the shop sensed by the sensor may be acquired as the person-related information of the person.

The determination unit 14 determines whether to permit the person who visit the shop to enter the shop, based on the person-related information acquired by the acquisition unit 13.

For example, when the acquisition unit 13 acquires at least either one of an image capturing the person who visits the shop and the voice data in which a content of a speech of the person who visits the shop is recorded, as the person-related information, the determination unit 14 determines, based on those pieces of data, whether appearance of the person, behavior of the person, or a content of a speech of the person satisfies a predetermined shop entry prohibition condition. When it is determined that the shop entry prohibition condition is not satisfied, the determination unit 14 permits the person to enter the shop, and when it is determined that the shop entry prohibition condition is satisfied, the determination unit 14 does not permit the person to enter the shop.

Otherwise, for example, when the acquisition unit 13 acquires the personal identification information as the person-related information, the determination unit 14 refers to a customer database (storage unit) prepared in advance, and acquires person attribute information, which is information associated with the determined personal identification information. The person attribute information is information indicating an attribute of the person. One example of details of the person attribute information will be described below. In the customer database, the personal identification information and the person attribute information of each person are registered in association with each other. Further, the determination unit 14 determines whether the acquired person attribute information satisfies a predetermined shop entry prohibition condition. When it is determined that the shop entry prohibition condition is not satisfied, the determination unit 14 permits the person to enter the shop, and when it is determined that the shop entry prohibition condition is satisfied, the determination unit 14 does not permit the person to enter the shop. The customer database may be stored in an in-shop server, in a center server that manages a plurality of shops, or in another place.

Otherwise, for example, when the acquisition unit 13 acquires the biological information as the person-related information, the determination unit 14 refers to a customer database prepared in advance, and acquires the personal identification information (customer identification information) of the person. In the customer database, the personal identification information and the biological information of each person are registered in association with each other. Processing after acquiring the personal identification information is similar to processing in the above-described case where the personal identification information is acquired as the person-related information.

Otherwise, for example, when the acquisition unit 13 acquires a result of sensing performed by any sensor, as the person-related information, the determination unit 14 determines whether a state of the person who visits the shop indicated by the result of sensing satisfies a predetermined shop entry prohibition condition. When it is determined that the shop entry prohibition condition is not satisfied, the determination unit 14 permits the person to enter the shop, and when it is determined that the shop entry prohibition condition is satisfied, the determination unit 14 does not permit the person to enter the shop.

Note that, details of the above-described determination processing by the determination unit 14 will be further clarified in the following example embodiments.

The operation control unit 16 controls operation of the shop entry control apparatus 11, based on a result of the determination by the determination unit 14.

For example, a normal state of the shop entry control apparatus 11 may be the second state (the state in which the gate or the door is closed) in which passage (entry into the shop) is refused. Further, when the determination unit 14 determines to permit the person who visits the shop to enter the shop, the operation control unit 16 may input, to the shop entry control apparatus 11, a control signal that brings the shop entry control apparatus 11 into the first state (the state in which the gate or the door is open) in which passage (entry into the shop) is permitted. Meanwhile, when the determination unit 14 determines that the person who visits the shop is not permitted to enter the shop, the operation control unit 16 may not input a control signal to the shop entry control apparatus 11.

Otherwise, for example, the normal state of the shop entry control apparatus 11 may be the first state (the state in which the gate or the door is open) in which passage (entry into the shop) is permitted. Further, when the determination unit 14 determines that the person who visits the shop is not permitted to enter the shop, the operation control unit 16 may input, to the shop entry control apparatus 11, a control signal that brings the shop entry control apparats 11 into the second state (the state in which the gate or the door is closed) in which passage (entry into the shop) is refused. Meanwhile, when the determination unit 14 determines that the person who visits the shop is permitted to enter the shop, the operation control unit 16 may not input a control signal to the shop entry control apparatus 11.

Otherwise, for example, when the determination unit 14 determines that the person who visits the shop is permitted to enter the shop, the operation control unit 16 may input, to the shop entry control apparatus 11, a control signal that brings the shop entry control apparatus 11 into the first state (the state in which the gate or the door is open) in which passage (entry into the shop) is permitted. Further, when the determination unit 14 determines that the person who visits the shop is not permitted to enter the shop, the operation control unit 16 may input, to the shop entry control apparatus 11, a control signal that brings the shop entry control apparatus 11 into the second state (the state in which the gate or the door is closed) in which passage (entry into the shop) is refused.

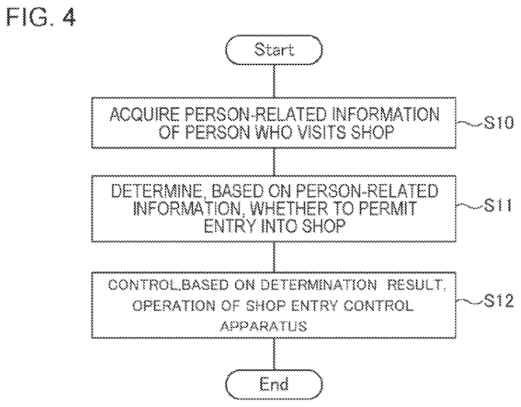

Next, one example of a processing flow of the shop system 10 will be described by using a flowchart in FIG. 4.

When the acquisition unit 13 acquires, from the information acquisition terminal 12, the person-related information about a person who visits the shop (S10), the determination unit 14 determines whether to permit the person who visits the shop to enter the shop, based on the person-related information acquired in S10 (S11).

Then, the operation control unit 16 controls operation of the shop entry control apparatus 11, based on a result of the determination in Sll (S12). Specifically, when it is determined to permit the person who visits the shop to enter the shop, the operation control unit 16 performs control for bringing the shop entry control apparatus 11 into a state of allowing passage. Meanwhile, when it is determined not to permit the person who visits the shop to enter the shop, operation control unit 16 performs control for bringing the shop entry control apparatus 11 into a state of not allowing passage.

The shop system 10 according to the present example embodiment described above is capable of detecting a person who has a possibility to hinder safe business operation among those who visit the shop and refusing entry into the shop to the detected person. The shop system 10 is capable of preventing a person who has a possibility to hinder safe business operation from entering the shop, and therefore occurrence of an inconvenience that hinders safe business operation can be reduced.

Further, since it is possible to determine whether each person has a possibility to hinder safe business operation, based on the person-related information of each person who visits the shop, the determination can be performed with high accuracy.

### Second Example Embodiment

In the present example embodiment, details of information acquired by an acquisition unit 13, and the above-described determination processing by the determination unit 14 will be further specified.

The acquisition unit 13 acquires, as person-related information, state information indicating a state of a person who visits a shop. Further, the determination unit 14 permits the person who visits the shop to enter the shop when the state information does not satisfy a shop entry prohibition condition, and does not permit the person who visits the shop to enter the shop when the state information satisfies the shop entry prohibition condition. A specific example will be described below.

### Example 1

In the present example, an information acquisition terminal 12 is an alcohol detector. The acquisition unit 13 acquires a result of detection by the alcohol detector, as the state information. Further, the determination unit 14 permits the person who visits the shop to enter the shop when the result of detection by the alcohol detector does not satisfy a shop entry prohibition condition, and does not permit the person who visits the shop when the result of detection by the alcohol detector satisfies the shop entry prohibition condition. The shop entry prohibition condition is that “alcohol concentration is equal to or higher than a reference value”.

For example, the person who visits the shop and comes in front of the shop entry control apparatus 11 performs an action (breathing on a predetermined spot, or the like) for an alcohol test against the alcohol detector installed in a vicinity of the shop entry control apparatus 11. When a detection result does not satisfy the shop entry prohibition condition, a shop system 10 brings the shop entry control apparatus 11 into a state of allowing passage, and when the detection result satisfies the shop entry prohibition condition, the shop system 10 brings the shop entry control apparatus 11 into a state of not allowing passage.

Otherwise, the “alcohol detector” and an “apparatus (a fingerprint sensor, a camera, a microphone, or the like) for acquiring biological information or an apparatus (a reader, a touch panel, a physical button, a microphone, a keyboard, a mouse, or the like) for inputting personal identification information” may be installed at short distance from the shop entry control apparatus 11, and acquisition of the biological information or the personal identification information may be performed along with an alcohol test using the alcohol detector. Further, the shop system 10 may store the biological information or the personal identification information, in association with a result of the alcohol test. In this case, the above-described apparatus for acquiring the biological information or the above-described apparatus for acquiring the personal identification information is also installed in a vicinity of the shop entry control apparatus 11. Further, when acquiring, via those apparatuses, the biological information or the personal identification information of the person who visits the shop and comes in front of the shop entry control apparatus 11, the shop system 10 retrieves the result of the alcohol test associated with the acquired biological information or the acquired personal identification information, and controls operation of the shop entry control apparatus 11 according to the result.

### Example 2

In the present example, the information acquisition terminal 12 is a camera (hereinafter, a “state information acquisition camera”). The acquisition unit 13 acquires an image indicating appearance of a person who visits the shop, as state information. Further, the determination unit 14 permits the person who visits the shop to enter the shop when the appearance does not satisfy a shop entry prohibition condition, and does not permit the person who visit the shop to enter the shop when the appearance satisfies the shop entry prohibition condition.

The shop entry prohibition condition is, for example, “wearing a mask”, “wearing a cap”, “wearing sunglasses”, “hiding equal to or more than a predetermined percentage of a face”, “possessing a prohibited item (a knife, a gun, a hammer, a bag having equal to or larger than a specified size, an alcoholic beverage, and the like)”, “a condition acquired by connecting, by a logical operator, a plurality of the conditions exemplified herein”, and the like. Determination as to whether those shop entry prohibition conditions are satisfied can be achieved by using any image analysis means.

For example, the state information acquisition camera may be installed at a position and in an orientation of capturing an image of a person in front of the shop entry control apparatus 11. Further, when the appearance of the person who visits the shop included in the image generated by the state information acquisition camera does not satisfy the shop entry prohibition condition, the shop system 10 brings the shop entry control apparatus 11 into the state of allowing passage, and when the appearance of the person who visits the shop satisfies the shop entry prohibition condition, the shop system 10 brings the shop entry control apparatus 11 into the state of not allowing passage.

Otherwise, the “state information acquisition camera” and the “apparatus (a finger print sensor, a camera, a microphone, or the like) for acquiring the biological information or the apparatus (a reader, a touch panel, a physical button, a microphone, a keyboard, a mouse, or the like) for inputting the personal identification information” may installed at a short distance from the shop entry control apparatus 11, and acquisition of the biological information or the personal identification information may be performed along with image capturing of the person who visits the shop by the state information acquisition camera. Further, the shop system 10 may store the biological information or the personal identification information, in association with a determination result, which is based on the image generated by the state information acquisition camera, as to whether the shop entry prohibition condition is satisfied. In this case, the above-described apparatus for acquiring the biological information or the above-described apparatus for inputting the personal identification information is also installed in a vicinity of the shop entry control apparatus 11. Further, when acquiring, via these apparatuses, the biological information or the personal identification information of the person who visits the shop and comes in front of the shop entry control apparatus 11, the shop system 10 retrieves the determination result, which is associated with the acquired biological information or the acquired personal identification information, as to whether the above-described shop entry prohibition condition is satisfied, and controls operation of the shop entry control apparatus 11 according to the result.

Other configurations of the shop system 10 are similar to those in the first example embodiment.

By the shop system 10 according to the present example embodiment, an advantageous effect similar to that in the first example embodiment is achieved. Further, by the shop system 10 according to the present example embodiment, a state of a person who visits the shop at a time of his or her visit to the shop can be recognized, and determination whether to permit the person to enter the shop can be made based on the recognized state. For example, the shop system 10 is capable of refusing entry into the shop to a person who is drunk, a person who is 0 trying to conceal his/her identity in disguise, a person who possesses a prohibited item, or the like. By such a shop system 10, occurrence of an inconvenience that hinders safe business operation can be more effectively reduced.

### Third Example Embodiment

In the present example embodiment, details of information acquired by an acquisition unit 13 and the above-described determination processing by the determination unit 14 will be further specified.

The acquisition unit 13 acquires, as person-related information, behavior information indicating a content of behavior of a person who visits a shop, in a vicinity of the shop. Further, the determination unit 14 permits the person who visits the shop to enter the shop when the behavior information does not satisfy a shop entry prohibition condition, and does not permit the person who visits the shop to enter the shop when the behavior information satisfies the shop entry prohibition condition. A specific example will be described blow.

### Example

In the present example, an information acquisition terminal 12 is a camera (hereinafter, a “behavior information acquisition camera”). The acquisition unit 13 acquires an image (moving image) indicating a content of behavior of a person who visits the shop, as behavior information. The image may be an image with voice, or may be an image without voice. The determination unit 14 permits a person who has not conducted a prohibited behavior, which is defined by the shop entry prohibition condition, to enter the shop, and does not permit a person who has conducted the prohibited behavior, which is defined by the shop entry prohibition condition, to enter the shop.

The prohibited behavior defined by the shop entry prohibition condition is, for example, “being drunk and staggering”, “drinking an alcoholic beverage (conducting a motion of drinking an alcoholic beverage held in hand, and the like)”, “making noise with loud voice (a volume of speaking voice is equal to or more than a threshold value, and the like)”, “a condition acquired by connecting, by a logical operator, a plurality of the condition exemplified herein”, and the like. Determination as to whether the shop entry prohibition condition is satisfied can be achieved by using any image analysis means or any voice analysis means.

For example, the behavior information acquisition camera may be installed at a position and in an orientation of capturing an image of a person in front of and around the shop entry control apparatus 11. Further, when detecting one or a plurality of persons in an image generated by the behavior information acquisition camera, a shop system 10 may monitor whether behavior of each of the persons falls under the prohibited behavior while tracking each of the detected persons in the image. Then, when detecting that any one of the persons being tracked in the image comes in front of the shop entry control apparatus 11, the shop system 10 controls operation of the shop entry control apparatus 11, based on a result of analysis of behavior that has been conducted by the person. Specifically, when the person has not conducted the prohibited behavior, the shop system 10 brings the shop entry control apparatus 11 into a state of allowing passage, and when the person has conducted the prohibited behavior, the shop system 10 brings the shop entry control apparatus 11 into a state of not allowing passage.

Otherwise, the behavior information acquisition camera may be installed at any position in a vicinity of the shop in any orientation. Further, when detecting one or a plurality of persons in an image generated by the behavior information acquisition camera, the shop system 10 may monitor whether behavior of each of the persons falls under the prohibited behavior while tracking each of the detected persons in the image. Further, the shop system 10 may extract, from the image, a feature value (a feature value of a face) of appearance of each of the detected persons, and store the feature value of the face and a result of the above-described monitoring, in association with each other.

In this case, another camera is installed at a position and in an orientation of capturing an image of a person in front of the shop entry control apparatus 11. Further when extracting a feature value of a face of the person from an image generated by the another camera, the shop system 10 retrieves a result of the above-described monitoring associated with the feature value of the face, and controls operation of the shop entry control apparatus 11 according to the result.

Other configurations of the shop system 10 is similar to those in the first and second example embodiments.

By the shop system 10 according to the present example embodiment, an advantageous effect similar to that in the first and second example embodiments is achieved. Further, by the shop system 10 according to the present example embodiment, a content of behavior of a person who visits the shop that has been conducted before the person enters the shop can be recognized, and determination whether to permit the person to enter the shop can be made based on the recognized content of behavior. For example, the shop system 10 is capable of refusing entry into the shop to a person who is drunk and staggering, a person who is drinking an alcoholic beverage, a person who is making noise with loud voice, and the like. By such a shop system 10, occurrence of an inconvenience that hinders safe business operation can be more effectively reduced.

### Fourth Example Embodiment

In the present example embodiment, details of information acquired by an acquisition unit 13 and the above-described determination processing by the determination unit 14 will be further specified.

The acquisition unit 13 acquires, as person-related information, personal identification information of a person who visits a shop. Acquisition of the personal identification information of the person who visits the shop may be achieved by acquiring biological information via a biological information acquisition apparatus or by a user input via an input apparatus such as a reader, a touch panel, a physical button, a microphone, a keyboard, a mouse, or the like, as described in the first example embodiment. For example, the person who visits the shop and comes in front of a shop entry control apparatus 11 performs operation of inputting the personal identification information to a shop system 10 via an information acquisition terminal 12 installed in a vicinity of the shop entry control apparatus 11.

The determination unit 14 acquires, from a customer database (storage unit) prepared in advance, person attribute information associated with the acquired personal identification information. Further, the determination unit 14 permits the person who visits the shop to enter the shop when the acquired person attribute information does not satisfy a shop entry prohibition condition, and does not permit the person who visits the shop to enter the shop when the acquired person attribute information satisfies the shop entry prohibition condition. A specific example will be described below.

### Example 1

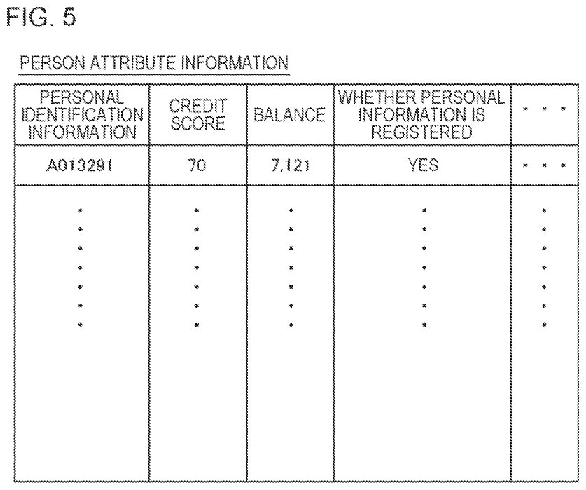

In the present example, as illustrated in FIG. 5, the person attribute information includes a credit score computed based on a past transaction. The determination unit 14 permits the person who visits the shop to enter the shop when the credit score is equal to or more than a first reference value, and does not permit the person who visits the shop to enter the shop when the credit score is less than the first reference value.

Herein, one example of processing of computing the credit score, based on a past transaction, is described. Note that, the example described herein is merely one example, and other processing may be used to compute the credit score.

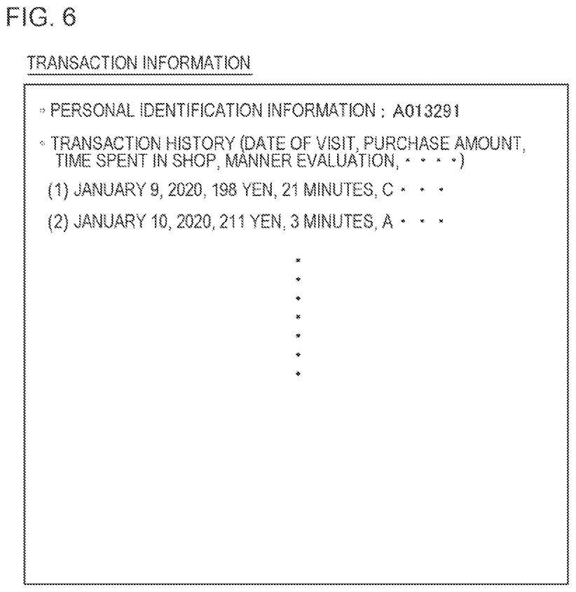

One example of transaction information indicating a content of a past transaction is illustrated in FIG. 6. The transaction information is stored in a center server, for example. The transaction information includes a performance and a content of evaluation of each person at each time of visiting the shop in the past. For example, as illustrated, the transaction information includes a date of visit, a purchase amount, a time spent in the shop, an in-shop manner, and the like.

The in-shop manner is computed based on an image generated by a surveillance camera installed in the shop. For example, in-shop prohibited behavior may be defined in advance. Further, a prohibition level may be defined for each in-shop prohibited behavior. Further, a shop-visit manner at a time of visiting the shop of each person may be computed based on whether the in-shop prohibited behavior is detected and the in-shop prohibited behavior of which prohibition level is detected. Details of a computation algorithm are not particularly limited. Examples of the in-shop prohibited behavior include “returning a product that has been picked up to a position different from where the product was originally displayed”, “running”, “making noise with loud voice”, “behaving suspiciously (looking around restlessly, wandering around, and the like)”, and the like.

The credit score is computed for each transaction (for each time of visiting the shop), based on information (an arithmetic expression, a table, and the like) for computing the credit score from a value of various parameters (the purchase amount, the time spent in the shop, the in-shop manner, and the like) included in the above-described transaction information, and the transaction information as illustrated in FIG. 6. Further, a statistic value (a mean value, a mode value, a maximum value, a minimum value, a median value, or the like) of the computed credit score for each time of visiting the shop is set as the credit score of the person.

Note that, instead of or in addition to the past transaction, a state of asset holdings, an educational background, a work history, and the like may be used as parameters for computing the credit score. The more assets the person owns, the higher the credit score becomes. Further, the more the educational background satisfies a predetermined condition (being a college graduate, having graduated a predetermined college, and the like), the higher the credit score becomes. Further, the more the work history satisfies a predetermined condition (the number of years of service is equal to or more than a reference, working for a predetermined company, and the like), the higher the credit score becomes. An algorithm for computing the credit score from those parameters is not particularly limited.

### Example 2

In the present example, as illustrated in FIG. 5, the person attribute information includes a balance of one or a plurality of payment methods available at the shop. The payment method is electronic money, a point, and the like. The shop may only accept payment by that payment method. Further, when the balance is equal to or more than a second reference value, the determination unit 14 permits the person who visits the shop to enter the shop, and when the balance is less than the second reference value, the determination unit 14 does not permit the person who visits the shop. Note that, when there are a plurality of payment methods available at the shop, the determination unit 14 permits the person who visits the shop to enter the shop when a balance of at least one of the payment methods is equal to or more than the second reference value, and does not permit the person who visits the shop to enter the shop when the balances of all payment methods are less than the second reference value. The second reference value may be a price including tax of a cheapest product being sold in the shop or a price lower than the price including tax.

### Example 3

In the present example, as illustrated in FIG. 5, the person attribute information includes whether personal information is registered. The personal information is information for determining an individual, such as a name, an address, a phone number, or the like. Examples of a means for registration of the personal information includes, but are not limited to, registration via a web site or an application of the shop, and registration by a phone call or a letter. Further, the determination unit 14 permits a person whose personal information is registered to enter the shop, and does not permit a person whose personal information is not registered to enter the shop.

### Example 4

In the present example, as illustrated in FIG. 5, the person attribute information includes at least two of the credit score, the balance of the one or a plurality of payment methods available at the shop, and whether the personal information is registered. Further, the determination unit 14 permits entry into the shop when a condition acquired by connecting, by a logical operator, any two or more of “the credit score is less than the first reference value”, “the balance is less than the second reference value”, and “the personal information is not registered” is not satisfied, and does not permit entry into the shop when the condition is satisfied.

Other configurations of the shop system 10 are similar to those in the first to third example embodiments.

By the shop system 10 according to the present example embodiment, an advantageous effect similar to that in the first to third example embodiments is achieved. Further, by the shop system 10 according to the present example embodiment, whether to permit a person who visits the shop to enter the shop can be determined based on the person attribute information indicating an attribution of the person who visits the shop, which is registered in a customer database (storage unit). For example, the shop system 10 is capable of refusing entry into the shop to a person whose credit score computed from a past transaction is low, a person whose balance of a payment method available at the shop is low, a person whose personal information for determining an individual is not registered, and the like. By such a shop system 10, occurrence of an inconvenience that hinders safe business operation can be more effectively reduced.

### Fifth Example Embodiment

A shop system 10 according to the present example embodiment includes a means for notifying that, when it is determined not to permit a person who visits a shop to enter the shop, matter to a system of a surveillance center. For example, the shop system 10 performs the above-described notification in response to a determination that the person who visits the shop is not permitted to enter the shop, or an input of a notification request to the surveillance center by the person after the determination.

The notification notifies that an event has occurred in which the person who visits the shop is not permitted to enter the shop. The notification may notify information that identifies the shop where the event has occurred and a reason why it is determined that the person who visits the shop is not permitted to enter the shop. Further, basis for that determination (an image, voice data, person attribute information, and the like) or a live image of the person who visits the shop may be transmitted to the system of the surveillance center.

Further, an operation control unit 16 of the shop system 10 may control operation of a shop entry control apparatus 11, based on a control instruction received from the system of the surveillance center. Specifically, an operator of the surveillance center examines, based on a content of the notification such as described above, validity of a determination of permitting the person to enter the shop. Then, when determining that it is allowable to permit the person to enter the shop, an operator of the surveillance center performs an input of bringing the shop entry control apparatus 11 into a state of allowing passage, to the system of the surveillance center. In response to the input, the system of the surveillance center transmits a control instruction for bringing the shop entry control apparatus 11 into the state of allowing passage, to the shop system 10.

Other configurations of the shop system 10 are similar to those in the first to fourth example embodiments.

By the shop system 10 according to the present example embodiment, an advantageous effect similar to that in the first to fourth example embodiments is achieved. Further, by the shop system 10 according to the present example embodiment, the shop entry control apparatus 11 can be brought into the state of allowing passage, by a remote control from the surveillance center, even when the shop system 10 does not permit entry into the shop. Therefore, a loss of sales opportunity due to an incorrect determination by the shop system 10 can be avoided.

Further, the reason why it is determined that the person who visits the shop is not permitted to enter the shop, the basis for that determination (the image, the voice data, the person attribute information, and the like), the live image of the person who visits the shop, and the like are transmitted to the system of the surveillance center. On the basis of those pieces of information, an operator of the surveillance center can examine validity of the determination made by the shop system 10, and decide whether to permit entry into the shop. In this way, by the shop system 10, useful information for the decision making by an operator of the surveillance center can be provided. As a result, occurrence of an inconvenience that an operator of the surveillance center makes an incorrect decision can be reduced.

Note that, in the present description, “acquisition” may include “retrieving data stored in another apparatus or a storage medium by an own device (active acquisition)”, based on a user input or based on a program instruction, for example, receiving data by making a request or query to another apparatus, reading data by accessing another apparatus or the storage medium, and the like. Further, “acquisition” may also include “inputting data output from another apparatus to an own device (passive acquisition)”, based on a user input or based on a program instruction, for example, receiving data that are distributed (transmitted, notified by a push notification, or the like), and the like. Further, “acquisition” may also include selecting and acquiring data or information from received data or information, and “generating new data by editing data (converting the data into text, reordering the data, extracting some pieces of the data, changing a file format, and the like) and acquiring the new data”.

A part or all of the above-described example embodiments can be described as the following supplementary notes, but is not limited thereto.

1. A shop system including:
an acquisition unit that acquires, from an information acquisition terminal, person-related information about a person who visits a shop;
a determination unit that determines, based on the person-related information, whether to permit the person who visits the shop to enter the shop; and
an operation control unit that controls, based on a result of the determination, operation of a shop entry control apparatus that controls entry into the shop.

2. The shop system according to supplementary note 1, wherein
the acquisition unit acquires, as the person-related information, personal identification information of the person who visits the shop, and
the determination unit acquires, from a storage unit storing the personal identification information and person attribute information indicating an attribute of the person in association with each other, the person attribute information associated with personal identification information of the person who visits the shop, and determines whether to permit the person who visits the shop to enter the shop, based on the acquired person attribute information.

3. The shop system according to supplementary note 2, wherein
the person attribute information includes a credit score computed based on a past transaction, and
the determination unit permits the person who visits the shop to enter the shop when the credit score is equal to or more than a first reference value, and does not permit the person who visits the shop to enter the shop when the credit score is less than the first reference value.

4. The shop system according to supplementary note 2 or 3, wherein the person attribute information includes a balance of a payment method available at the shop, and
the determination unit permits the person who visits the shop to enter the shop when the balance is equal to or more than a second reference value, and does not permit the person who visits the shop to enter the shop when the balance is less than the second reference value.

5. The shop system according to any one of supplementary notes 2 to 4, wherein
the acquisition unit acquires, as the person-related information, behavior information indicating a content of behavior of the person who visits the shop in a vicinity of the shop, and
the determination unit permits the person who visits the shop to enter the shop when the behavior information does not satisfy a shop entry prohibition condition, and does not permit the person who visits the shop to enter the shop when the behavior information satisfies the shop entry prohibition condition.

6. The shop system according to any one of supplementary notes 2 to 5, wherein
the acquisition unit acquires, as the person-related information, state information indicating a state of the person who visits the shop, and
the determination unit permits the person who visits the shop to enter the shop when the state information does not satisfy a shop entry prohibition condition, and does not permit the person who visits the shop to enter the shop when the state information satisfies the shop entry prohibition condition.

7. The shop system according to supplementary note 6, wherein the acquisition unit acquires, as the state information, a result of detection performed by an alcohol detector.

8. The shop system according to supplementary note 6 or 7, wherein the acquisition unit acquires, as the state information, an image indicating appearance of the person who visits the shop.

9. A processing method including:
by a computer,
acquiring, from an information acquisition terminal, person-related information about a person who visits a shop;
determining, based on the person-related information, whether to permit the person who visits the shop to enter the shop; and
controlling, based on a result of the determination, operation of a shop entry control apparatus that controls entry into the shop.

10. A program causing a computer to function as:
an acquisition unit that acquires, from an information acquisition terminal, person-related information about a person who visits a shop;
a determination unit that determines, based on the person-related information, whether to permit the person who visits the shop to enter the shop; and
an operation control unit that controls, based on a result of the determination, operation of a shop entry control apparatus that controls entry into the shop.

While the invention of the present application has been described with reference to the example embodiments (and examples) thereof, the invention of the present application is not limited to the above-described example embodiments (and examples). Various modifications that can be understood by a person skilled in the art may be made in configuration and details of the invention of the present application within the scope of the invention of the present application.

This application is based upon and claims the benefit of priority from Japanese patent application No. 2020-049289, filed on Mar. 19, 2020, the disclosure of which is incorporated herein in its entirety by reference.

### REFERENCE SIGNS LIST

1A Processor
2A Memory
3A Input/output I/F
4A Peripheral circuit
5A Bus
10 Shop system
11 Shop entry control apparatus
12 Information acquisition terminal
13 Acquisition unit
14 Determination unit
16 Operation control unit
20 Controller

What is claimed is:

1. A shop system comprising:
at least one memory configured to store one or more instructions; and
at least one processor configured to execute the one or more instructions to:
acquire, from an information acquisition terminal, person-related information about a person who visits a shop;
determine, based on the person-related information, whether to permit the person who visits the shop to enter the shop; and
control, based on a result of the determination, operation of a shop entry control apparatus that controls entry into the shop.

2. The shop system according to claim 1, wherein the processor is further configured to execute the one or more instructions to:
acquire, as the person-related information, personal identification information of the person who visits the shop, and
acquire, from a storage unit storing the personal identification information and person attribute information indicating an attribute of the person in association with each other, the person attribute information associated with personal identification information of the person who visits the shop, and determine whether to permit the person who visits the shop to enter the shop, based on the acquired person attribute information.

3. The shop system according to claim 2, wherein
the person attribute information includes a credit score computed based on a past transaction, and
the processor is further configured to execute the one or more instructions to permit the person who visits the shop to enter the shop when the credit score is equal to or more than a first reference value, and not permit the person who visits the shop to enter the shop when the credit score is less than the first reference value.

4. The shop system according to claim 2, wherein
the person attribute information includes a balance of a payment method available at the shop, and
the processor is further configured to execute the one or more instructions to permit the person who visits the shop to enter the shop when the balance is equal to or more than a second reference value, and docs not permit the person who visits the shop to enter the shop when the balance is less than the second reference value.

5. The shop system according to claim 2, wherein the processor is further configured to execute the one or more instructions to:
acquire, as the person-related information, behavior information indicating a content of behavior of the person who visits the shop in a vicinity of the shop, and
permit the person who visits the shop to enter the shop when the behavior information does not satisfy a shop entry prohibition condition, and not permit the person who visits the shop to enter the shop when the behavior information satisfies the shop entry prohibition condition.

6. The shop system according to claim 2, wherein the processor is further configured to execute the one or more instructions to:
acquire, as the person-related information, state information indicating a state of the person who visits the shop, and
permit the person who visits the shop to enter the shop when the state information does not satisfy a shop entry prohibition condition, and not permit the person who visits the shop to enter the shop when the state information satisfies the shop entry prohibition condition.

7. The shop system according to claim 6, wherein
the processor is further configured to execute the one or more instructions to acquire, as the state information, a result of detection performed by an alcohol detector.

8. The shop system according to claim 6, wherein
the processor is further configured to execute the one or more instructions to acquire, as the state information, an image indicating appearance of the person who visits the shop.

9. A processing method comprising:
by a computer,
acquiring, from an information acquisition terminal, person-related information about a person who visits a shop;
determining, based on the person-related information, whether to permit the person who visits the shop to enter the shop; and
controlling, based on a result of the determination, operation of a shop entry control apparatus that controls entry into the shop.

10. A non-transitory storage medium storing a program causing a computer to:
acquire, from an information acquisition terminal, person-related information about a person who visits a shop;
determine, based on the person-related information, whether to permit the person who visits the shop to enter the shop; and
control, based on a result of the determination, operation of a shop entry control apparatus that controls entry into the shop.
